(19) United States
(12) Patent Application Publication
(10) Pub. No.: US 2019/0224883 A1
(43) Pub. Date: Jul. 25, 2019

(54) MOLDING UNIT FOR THE PRODUCTION OF SANITARY WARES

(71) Applicant: SITI-B&T GROUP S.P.A., Formigine (IT)

(72) Inventor: Marra Elio Cristoforo, Formigine (IT)

(73) Assignee: SITI-B&T GROUP S.P.A., Formigine, MO (US)

(21) Appl. No.: 16/329,102

(22) PCT Filed: Jul. 6, 2017
(86) PCT No.: PCT/IB2017/054075

§ 371 Date: Feb. 27, 2019

(30) Foreign Application Priority Data
Sep. 22, 2016 (IT) 102016000095433

(51) Int. Cl. B28B 1/26; B28B 1/00

(52) U.S. Cl. CPC B28B 1/266; B28B 1/261; B28B 1/002

(57) ABSTRACT

Molding unit for the production of sanitary wares, comprising at least one support frame, at least one first portion and one second portion associated with the frame, bearing respectively at least one first molding component and one second molding component selectively connectable to each other, so as to define at least one molding cavity adapted to receive the casting of at least one pressurized fluid mixture which, once solidified, forms at least one sanitary ware. The first portion and the second portion are connected to the frame in the hanging configuration and are able to be selectively and mutually approachable in a closed configuration, so as to bring into mutual contact the molds to define the molding cavity, and mutually movable away from each other in an open configuration to allow the removal of the sanitary ware once formed. At least the first portion comprises clamping means selectively movable from an inactive position, corresponding to said open configuration, to an operating position, corresponding to said closed configuration, in which they act on at least one abutment zone provided in the second portion.

### TECHNICAL FIELD OF THE INVENTION

The present invention relates to a molding unit for the production of sanitary wares. More in detail, the present invention relates to a molding unit for the production of sanitary wares by pressure casting of slip inside a pressing unit.

### STATE OF THE ART

The production of sanitary wares is carried out with equipment wherein pressure casting of slip is carried out inside molding units of the modular type: each of these units comprises two or more portions which can be connected together to define a molding cavity, inside which slip, that is, in jargon, a fluid mixture containing an aqueous part and a suspended ceramic part, is then pressure cast.

The number of portions that make up each molding unit of the production equipment may vary depending on various factors.

Typically, this number varies with respect to the geometry of the item to be produced with reference, for example, to the presence or absence of portions or appendices into an undercut, of openings, or other geometric peculiarities.

The individual portions forming the molding unit, and which then define the cavity for slip casting, comprise respective molding components which, mutually coupled to each other so as to abut against each other at certain junction areas, define the above-mentioned cavity inside which the fluid mixture is directly poured.

Following the casting of the fluid mixture, the latter solidifies to produce the item having the desired shape: the individual portions of the molding unit—bearing the respective molding components—may, at this moment, be mutually distanced, to allow the extraction of the item itself, which will then be subjected to appropriate processes to obtain the final product.

Molds can be made, for example, of porous resin, which has replaced traditional gypsum over time: this material combines high mechanical strength, long life, lightness, and good water permeability properties so as to allow, during casting, the removal of the liquid part of the fluid mixture, promoting the rapid solidification of the same to obtain the desired item.

In the production equipments of such type, more molding units are usually attached to a support frame, in the hanging configuration; more particularly, said molding units are associated, in series, with a portal frame provided with at least one horizontal beam, to which the various molding units are hanged side by side so as to be slidably longitudinally movable along the same beam.

Therefore, in the different operating phases of the equipment, the individual portions forming each molding unit can be mutually approached and coupled in order to delimit, or mutually distanced to allow the extraction of, the sanitary ware from the molding cavity.

In preparation for the slip casting step, the various molding units, being slidable, are compressed against each other by special pressing means which are associated with opposing ends of the support frame: these pressing means are brought into direct contact, from opposite sides, with the lateral sides of the molding units disposed at the ends of the array, and they exert, on the molding units themselves, a tightening action having a horizontal direction, i.e. parallel to the axis of said support beam. This results in an action counteracting the stresses caused by the pressure of the poured fluid mixture into the molding cavities of the line, which ensures the correct realization of the items by limiting mold deformations and hence all the problems that may result therefrom.

As mentioned earlier, in the manufacture of certain types of sanitary wares, such as toilet bowls, bidets, or the like, and for reasons related to the particular conformation of the item to be manufactured, molding units comprising at least three mutually mobile portions, bearing respective molds, can be used.

Of these three portions, normally two portions laterally delimit the molding cavity, with the respective molding components, while a further portion may delimit, with the respective molding component, the cavity itself above, or below, or at any other position based on the geometry of the item to be molded.

Therefore, in the production equipment, the two above-mentioned lateral portions of each molding unit are respectively side by side with the portions of the adjacent molding units.

In some cases—for example, for reasons of particular complexity of the shape of the item to be produced or for other reasons, for example, for simplicity of extracting the article itself, each molding unit may include a number of mutually mobile portions higher than three, for example four or even five; in a typical application, two of these portions may be lateral, one upper, one lower and possibly one rear or front.

In these situations, the tightening and lateral containment effected by the pressing members of the support frame of the equipment may not in itself be sufficient to ensure the optimum contrast of the pressure of the poured fluid mixture into the molding cavities in the various directions in which it is performed.

In fact, some areas of the molds, or some junction areas between them, may become particularly critical as regards pressure stresses and consequent induced deformations, as well as with regard to the fluid seal of the molding cavity.

In some known production equipment, to solve these problems, further containing means—having, for instance, a frame-like conformation—have been developed, which externally encircle some of the portions of the molding unit to counteract the pressure of the fluid mix and keep the molding component in the correct position while molding the items.

A specific technical solution of this type provides that, between said containing means and some of the portions of the molding unit, inflatable elements with appropriate geometry and size are interposed.

During casting, or in any case in preparation of the same, the inflatable elements are filled with a suitable liquid or gaseous fluid, having a pressure such as to counterbalance slip pressure: the stresses and the possible consequent deformations of the molding components, including the stresses occurring along directions not parallel to the clamping action of the horizontal pressing members of the support frame, are thus limited.

The technical solution described above is not considered fully satisfactory under several points of view.

In fact, the inflatable elements, being positioned at mechanical parts that can move relative to each other, are subject to wear and therefore they often have to be replaced after a very limited number of production cycles, and there may be the risk of breakage and also the possibility of explosions with the risk of serious injury to operators.

Additionally, the contrast to fluid pressure effected with inflated elements cannot always be controlled and fine-tuned.

Thus, situations may arise in which, even within the same molding unit, the fluid pressure of the slip is well contrasted in certain areas but not in others, for example when the inflatable elements have sufficiently extended surfaces of contact with the mold: this may result in poorly uniform quality and homogeneity in the obtained products, or even residual stresses, breakage during extraction, and other drawbacks.

### OBJECTS OF THE INVENTION

The technical task of the present invention is to improve the state of the art in the field of equipment for the production of sanitary wares. Within the scope of this technical task, it is an object of the present invention to provide a molding unit for the production of sanitary ware to overcome the above-mentioned drawbacks.

Another object of the present invention is to provide a molding unit for the production of sanitary wares to effectively counteract the high pressure of the poured fluid into the molding cavities to ensure the correct coupling between the molding components of each molding unit.

Yet another object of the present invention is to provide a molding unit for the production of sanitary wares in which excessive deformations of molding components due to the high pressure at which the fluid mixture is cast are prevented.

A further object of the present invention is to provide a molding unit for the manufacture of sanitary wares where the joining areas of the molding components are properly maintained in mutual contact during the flow of the fluid mix.

Yet another object of the present invention is to provide a molding unit for constructively simple and cost-effective sanitary wares.

Another object of the present invention is to provide a molding unit for sanitary wares that is easy to use.

A further object of the present invention is to provide a molding unit for sanitary wares that has no flexible parts undergoing to wear, thus avoiding the danger of component explosion and which is therefore safe to be used by operators.

Not least, the object of the present invention is to fulfil all of the above-mentioned objects also in the field of the production of complex-shaped sanitary wares for the presence of undercuts, appendices, openings, and the like.

This task and these objects are all achieved by a molding unit for the manufacture of sanitary wares according to the appended claim 1.

The molding unit for the production of sanitary wares comprises at least one support frame, at least one first portion and one second portion associated with the frame, bearing respectively at least one first molding component and one second molding component selectively connectable to each other, so as to define at least one molding cavity adapted to receive the casting of at least one pressurized fluid mixture which, once solidified, forms at least one sanitary ware.

The first portion and the second portion are connected to the frame in the hanging configuration and are able to be selectively and mutually approachable in a closed configuration, so as to bring into mutual contact the molding components to define the molding cavity, and mutually movable away from each other in an open configuration to allow the removal of the sanitary ware once formed inside the cavity.

According to an aspect of the present invention, at least the first portion of the molding unit comprises clamping means selectively movable from an inactive position, corresponding to said open configuration, to an operating position, corresponding to said closed configuration, in which they act on at least one abutment zone provided in the second portion and corresponding to at least one junction surface between said first molding component and said second molding component in said closed configuration.

In an embodiment of the invention, said clamping means comprise at least one housing provided in the first portion and at least one pressing member defining at least one of the inner surfaces of said housing; in the closed configuration of the molding unit, the abutment zone of the second portion is at least partially engaged in the housing.

The dependent claims refer to preferred and advantageous embodiments of the invention.

### BRIEF DESCRIPTION OF THE DRAWINGS

Further features and advantages of the present invention will become apparent from the detailed description of a preferred, non-exclusive embodiment of a molding unit for the production of sanitary wares illustrated by way of non-limiting example, in the appended drawings, wherein

FIG. 1 is an axonometric view of the molding unit according to the present invention, in a closed configuration;

FIG. 2 is an axonometric view of the same molding unit, in an open configuration;

FIG. 3 is an axonometric view of detail of the first portion and of the second portion of the molding unit, in a closed configuration;

FIG. 4 is a detailed axonometric view of the first portion and of the second portion of the molding unit, with some parts removed for greater clarity;

FIG. 5 is a detailed axonometric view of some portions of the molding unit;

FIG. 6 is a detailed axonometric view of portions of the molding unit, from different angles, with some parts removed for greater clarity;

FIG. 7 is an exploded and detailed axonometric view of the clamping means of the molding unit, with some parts removed for clarity;

FIG. 8 is a detailed side view of parts of the second portion of the molding unit;

FIG. 9 is an axonometric view of the molding unit, wherein the portions of the molding unit are disconnected from the support frame and can therefore be freely removed.

### EMBODIMENTS OF THE INVENTION

With reference to the attached figures, a molding unit for the production of sanitary wares is generally indicated with the reference number 1.

The molding unit 1 comprises a support frame 2.

Furthermore, the molding unit 1 comprises at least one first portion 3 and one second portion 4.

The first portion 3 and the second portion 4 are associated with the frame 2.

The first portion 3 and the second portion 4 respectively have a first molding component 5 and a second molding component 6, respectively.

The first molding component 5 and the second molding component 6 can be replaced, for example, for maintenance purposes or to produce a different sanitary ware 8.

The first molding component 5 and the second molding component 6 can be selectively linked together so as to define at least one molding cavity 7. More particularly, the first molding component 5 and the second molding component 6 can be coupled to each other at one or more junction surfaces that delimit the molding cavity 7.

The molding cavity 7 is suitable for receiving the casting of at least one pressurized fluid mixture which, once solidified, forms at least one sanitary ware 8.

The sanitary ware 8 can be any; in some embodiments of the invention, the sanitary ware 8 may be, for example, a toilet bowl, a bidet or the like, without any particular limitation.

The sanitary ware 8 may have symmetrical conformation with respect to at least one plan, or it may also have a more complex conformation or no symmetry plan at all.

The first portion 3 and the second portion 4 are connected to the frame 2 in the hanging configuration, as will be further clarified in the following.

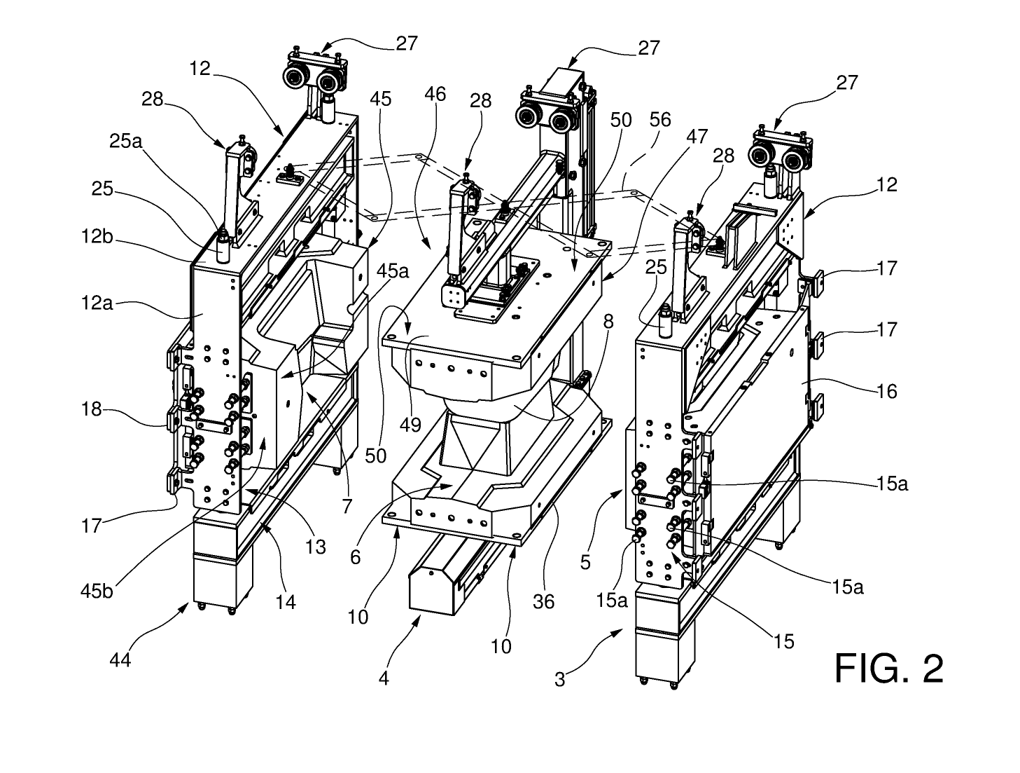

The first portion 3 and the second portion 4 are selectively and reciprocally approachable in a closed configuration—shown, for example, in FIG. 2—so as to bring into mutual contact the first molding component 5 and the second molding component 6 to define the above molding cavity 7.

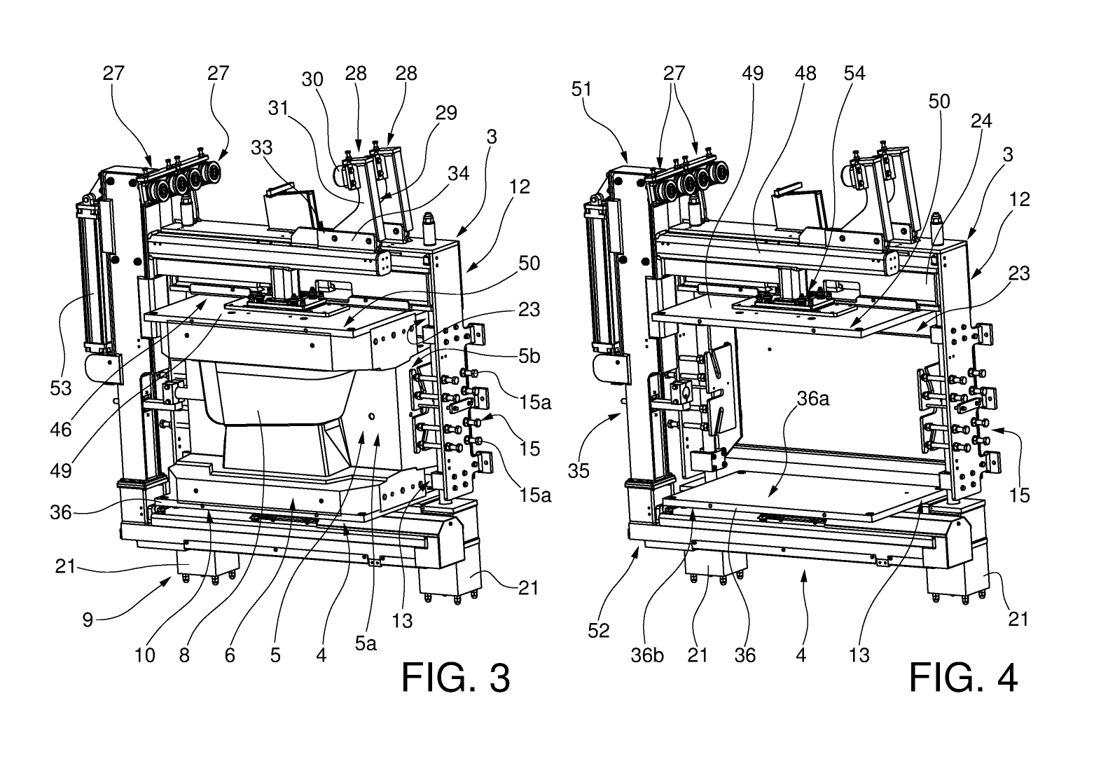

The first molding component 5, as shown in particular in FIG. 3, has a front surface 5a in which a recess is provided that helps define the molding cavity 7 of the sanitary ware 8.

In addition, the first molding component 5 has a perimeter surface 5b which does not contribute to defining the molding cavity 7, but fulfils other functions, for example constraining the first molding component 5 to the first portion 3, or coupling at least with the second molding component 6 along one or more junction surfaces, as will be better described below.

The first portion 3 and the second portion 4 are also mutually detachable in an open configuration—shown in FIG. 2—to permit the extraction of the sanitary ware 8 once formed within the molding cavity 7.

According to an aspect of the invention, the molding group 1 comprises clamping means 9.

More particularly, the first portion 3 of the molding unit 1 comprises clamping means 9.

The clamping means 9 are selectively movable from an inactive position, corresponding to said open configuration, to an operating position, corresponding to said closed configuration, in which they act on at least one abutment zone 10 of the second portion 4 and corresponding to at least one junction surface between the first molding component 5 and the second molding component 6 in the above-mentioned closed configuration.

The actuation of the clamping means 9 then allows, once this closed configuration is obtained, to exert from the outside of the molding cavity 7 a mechanical action which counteracts the pressure of the fluid mixture at the junction surfaces between the first molding component 5 and the second molding component 6.

The advantages of this solution with respect to the state of the art will be better understood once more details are given about the features of the clamping means 9.

The frame 2 comprises at least one horizontal or substantially horizontal structure 11.

The horizontal structure 11 is connected, in the hanging configuration, at least to the first portion 3 and the second portion 4, according to the modes best described below.

The first portion 3 of the molding unit 1 comprises a support reinforcement 12. The reinforcement 12 comprises at least three consecutive stretches 12a, 12b, 12c, connected to each other at reciprocal junctions, so as to conform a substantially inverted U-shaped structure.

In particular, the reinforcement 12 comprises: a first stretch 12a, a second stretch 12b, and a third stretch 12c, connected to each other in succession. The second stretch 12a, arranged centrally, is intended for the hanging connection to the horizontal structure 11 of frame 2.

The conformation of the reinforcement 12 of the first portion 3 may, however, be different from the one described, in relation to specific application needs, without any particular limitations.

The clamping means 9 provided in the first portion 3 of the molding unit 1 comprise at least one housing 13; the housing 13 is provided in the first portion 3.

In addition, the clamping means 9 comprise at least one pressing member 14. The pressing member 14 defines at least one of the inner surfaces of the housing 13 as will become clearer later on.

In the closed configuration of the molding unit 1, the abutment zone 10 of the second portion 4 is at least partially engaged in the housing 13.

More specifically, the housing 13 is defined by the pressing member 14 and by a portion of the perimeter surface 5b of the first molding component 5.

With reference to the configuration of use of the first portion 3, i.e. hanging from the horizontal structure 11, the first molding component 5 is connected to the reinforcement 12 at its rear surface and/or at the lateral sides of said perimeter surface 5b.

At the lateral sides of the perimeter surface 5b of the first molding component 5, clamping members 15 may be provided which serve to attach the mold to the reinforcement 12 and which can also be used to induce, in the same first molding component 5, a certain tension state, or elastic preload, which facilitates the contrast of the pressure of the fluid mixture that is cast when the molding unit 1 is in the closed configuration.

Said clamping members 15 can be, for example, of the screw type or other equivalent type.

In the embodiment shown in the figures, the clamping members 15 comprise a plurality of screws 15a engaged in respective threaded through-holes provided in the first stretch 12a and in the third stretch 12c of the reinforcement 12.

The rear face of the first molding component 5, which is opposed to the molding cavity 7, is associated with a respective rigid plate-shaped support 16.

The reinforcement 12 comprises lateral appendages 17 for fastening a flat member 18 parallel to said plate-shaped support 16, the function of which will become clearer later on.

According to another aspect of the invention, the pressing member 14 comprises at least one first cross member 19.

The first cross member 19 can be moved between said inactive and operating positions.

More in detail, the first cross member 19 comprises at least one pressure surface 20 adapted to act on the abutment zone 10 of the second portion 4; furthermore, the first cross member 19 defines one of the inner surfaces of the housing 13.

The pressure member 14 comprises at least one linear actuator 21; in turn, the linear actuator 21 comprises, more particularly, one cylinder 21a and one stem 21b which selectively comes out of the cylinder 21a; the linear actuator 21 could have an actuation of hydraulic, pneumatic or electric type or other type suitable for this particular application, without any particular limitations.

According to another aspect of the invention, the first cross member 19 is rigidly connected to the cylinder 21a of the linear actuator 21. According to a further aspect of the invention, the pressing member 14 comprises at least one rod 22.

The rod 22 connects coaxially the stem 21b of the linear actuator 21 to the reinforcement 12: in this way, the actuation of the linear actuator 21 determines the translation of the same first cross member 19 towards the reinforcement 12 and then towards the first and second molding components 5 and 6.

In the specific embodiment illustrated in the figures, and according to yet another aspect of the invention, the pressing member 14 of the first portion 3 comprises at least two linear actuators 21.

At least two linear actuators 21 have respective drive axes 21c substantially parallel to each other.

The drive axes 21c of the linear actuators 21 are positioned at a reciprocal distance which corresponds roughly to the distance between the first stretch 12a and the third stretch 12c of the reinforcement 12.

The first cross member 19 is rigidly connected, from opposite sides, to the cylinders 21a of the two linear actuators 21.

In addition, at least two rods 22 are provided, which coaxially connect the stems 21b of the two linear actuators 21 to the reinforcement 12.

According to another aspect of the invention, in this embodiment, the first cross member 19 of the pressing member 14 has a substantially elongated conformation and comprises at least two respective through-holes 19b at opposite ends 19a; these two through-holes 19b have axes which are parallel to each other.

Inside the aforementioned two through-holes 19b, the stems 21b of the linear actuators 21 and their respective rods 22 are slidably engaged.

According to yet another aspect of the invention, the first portion 3 comprises at least one seat 23.

With respect to the first molding component 5, the seat 23 is in the position opposite to the housing 13: this means that, in the configuration of use of the first portion 3, the seat 23 is located above the first molding component 5.

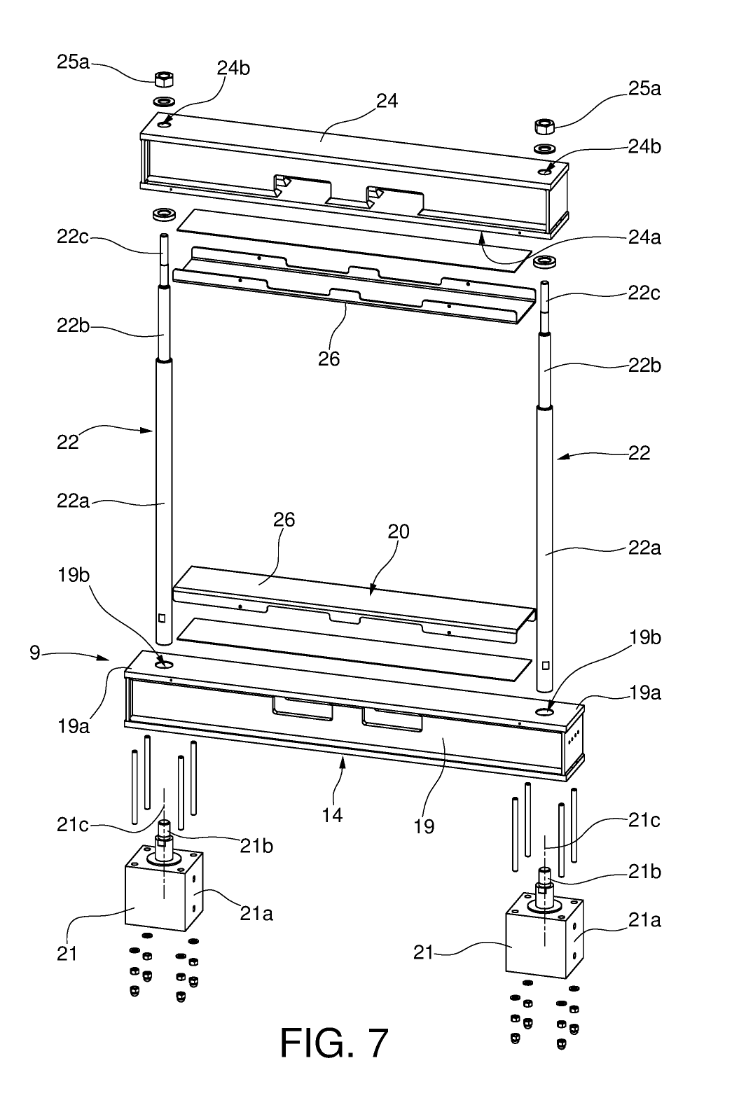

As shown in FIG. 7, at least one second cross member 24 is associated with the second stretch 12b of the reinforcement 12, with its lateral surface 24a delimiting said seat 23, along with the peripheral portion 5b of the first molding component 5. The second cross member 24 comprises two respective passage channels 24b which, in assembled configuration of the pressing member 14, are coaxial with the through-holes 19b of the first cross member 19.

More in detail, the ends of the rods 22 engage in the passage channels 24b.

Also with reference to FIG. 7, each of the rods 22 comprises—from the stem 21b towards the opposite end—a first part 22a having a first diameter, a second part 22b having a second diameter smaller than the first diameter, and a third threaded part 22c having a third diameter smaller than the second diameter.

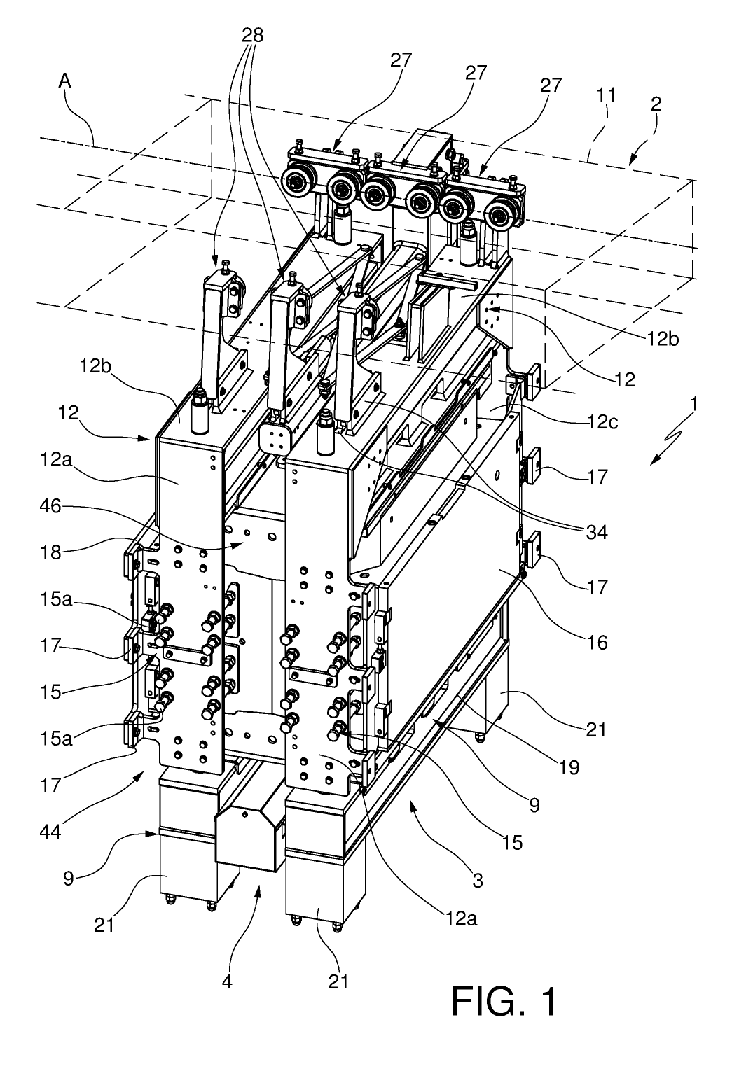

In the assembled configuration, the shoulder between the first part 22a and the second part 22b is located on the lateral surface 24a of the second cross member 24 so that the second part 22b is engaged within the respective passage channel 24b; finally, the third section 22c crosses the second section 12b of the reinforcement 12 (see FIGS. 1, 3 and 4) which is floatingly associated to the third part 22c by elastic means 25.

In detail, the elastic means 25 may include a helical spring 25 connecting the second stretch 12b to the third stretch 22c, and a nut 25a screwed along the latter. Alternatively, elastic means 25 may include elastomeric bushings or other types of elastic coupling.

Thus, the reinforcement 12 supports the pressing member 14 with elastic means 25 and, thanks to these elastic means 25, the pressing member 14 can move slightly with respect to the reinforcement 12, automatically finding a centred position relative to the molding components to be tightened.

In fact, the clamping force on the molding components is equally distributed on the first cross member 19 and the second cross member 24.

The first cross member 19 or second cross member 24 or both may include at least one respective cover element 26 defining the pressure surface 20 of the same first cross member 19.

The first portion 3 is connected to the horizontal structure 11 of the frame 2 by means of at least a first carriage element 27 and a second carriage element 28.

The first carriage element 27 and the second carriage element 28 are movable along respective tracks of the horizontal structure 11 so that the first portion 3 can be translated along a first direction A.

According to one aspect of the invention, at least the second carriage element 28 is selectively movable from a working position of coupling to the horizontal structure 11 to an inactive position of free decoupling of the first portion 3 from the horizontal structure 11 itself.

In other words, at least the second carriage element 28 may be selectively disengaged from the respective rail to remove the first portion 3 from the molding unit 1, for example for replacement, maintenance or other reasons.

In the embodiment of the invention illustrated in the figures, the second carriage element 28 comprises at least one bracket 29 articulated to fixed parts of the first portion 3; more in detail, the bracket 29 is articulated to the upper face of the second stretch 12b of the reinforcement 12.

In FIG. 9, said bracket 29 is shown in said inactive position of free decoupling. The bracket 29 is articulated to the first portion 3 along an articulation axis 29a parallel to said first direction A.

The bracket 29 has at least one respective wheel 30 for rolling along the respective track of said horizontal structure 11.

The bracket 29 is substantially square-shaped, and the articulation axis 29a is provided at the vertex of the bracket.

The bracket 29 comprises a first arm 31 and a second arm 32.

The wheel 30 is rotatably supported at the end portion of the first arm 31 of the bracket 29.

The second arm 32 of the bracket 29 allows it to be clamped in said coupling operating position: in particular, at the terminal end of the second arm 32, means of constraint 33 such as pins or screws or similar means may be provided.

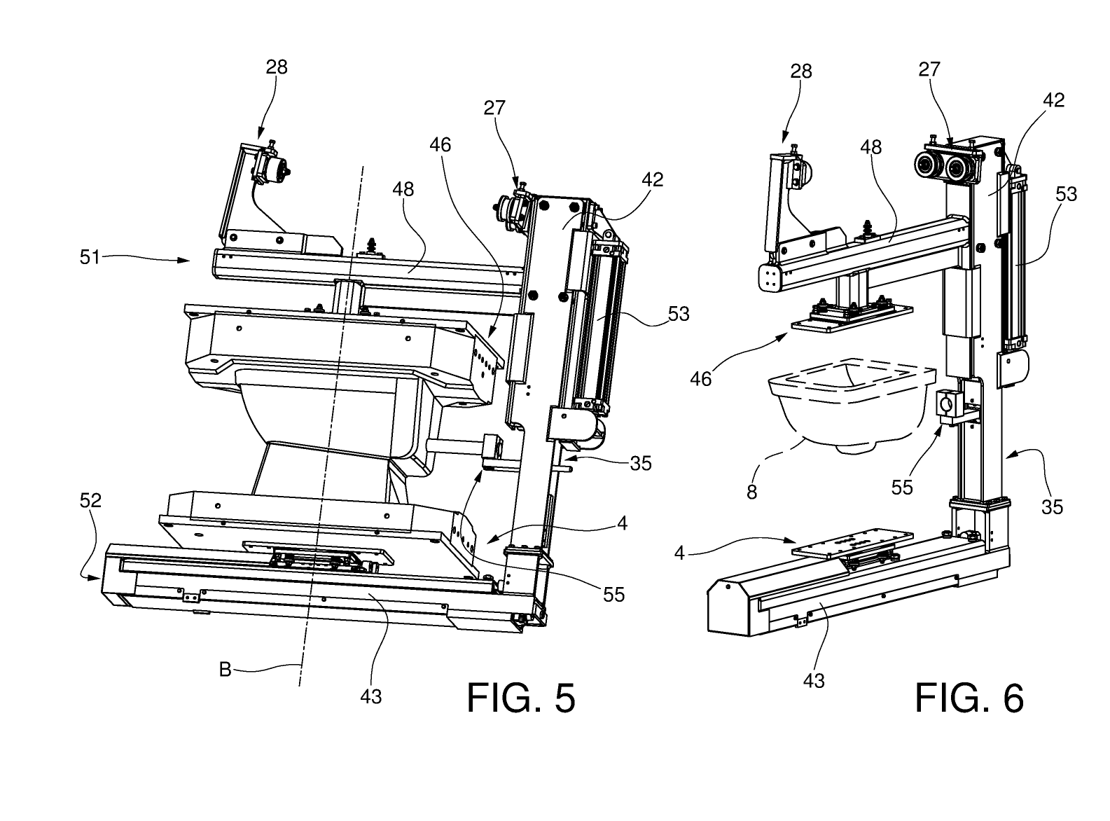

In the embodiment illustrated in the figures, the second stretch 12b of the reinforcement 12 conforms a pair of parallel ears 34, which allow the articulation of the bracket 29 to be realized; the same ears 34 comprise the aforementioned clamping means 33, which in turn comprise a screw 33a engageable in a respective hole 33b passing through both the ears 34 and the second arm 32 of the bracket 29. The second portion 4 of the molding unit 1 comprises a support frame 35 (FIGS. 5 and 6).

The frame 35 is connected in the hanging configuration to the horizontal structure 11 of the frame 2; the frame 35 is movable relative to said horizontal structure 11 along the first direction A.

The second molding component 6 is connected to the frame 35.

The second molding component 6 defines, along at least the first molding component 5 in said closed configuration, the molding cavity 7 of the sanitary ware 8.

According to an aspect of the invention, the abutment zone 10 for the clamping means 9 of the first portion 3, provided in the second portion 4, comprises at least one peripheral zone of the second molding component 6.

By peripheral zone is meant an area of the second molding component 6 arranged along at least one of the sides of the molding cavity 7.

In this way, the action of the clamping means 9, exerted at the periphery of the second molding component 6, counteracts the pressure exerted by the fluid mixture and prevents deformations of molding components 5, 6 at the respective coupling and junction areas, and thus prevents the possible negative consequences that might result from this.

More in detail, the second portion 4 comprises at least one rigid platform 36.

Such platform 36 comprises a first face 36a to which the second molding component 6 is connected; furthermore, the platform 36 comprises a second face 36b, opposed to the first face 36a, comprising said abutment zone 10 for the clamping means 9 of the first portion 3.

In a version of the invention corresponding to the one shown in the figures, the abutment zone 10 is provided at the periphery of the platform 36; more particularly, such an abutment zone 10 is provided along at least one edge of the platform 36, on the first face 36a.

The platform 36 is associated to the frame 35 by elastic connecting means 37.

This allows to obtain effective reciprocal adhesion of molding components 5 and 6 when the molding unit 1 is in its closed configuration, since the elastic connection also allows to compensate for any small dimensional differences in the molding components 5 and 6, or in the alignment of the mechanical parts.

In other words, by means of elastic connecting means 37, the pressing member 14 can act by effectively closing the molding components 5 and 6, since the latter ones are free to move slightly with respect to the frame 35.

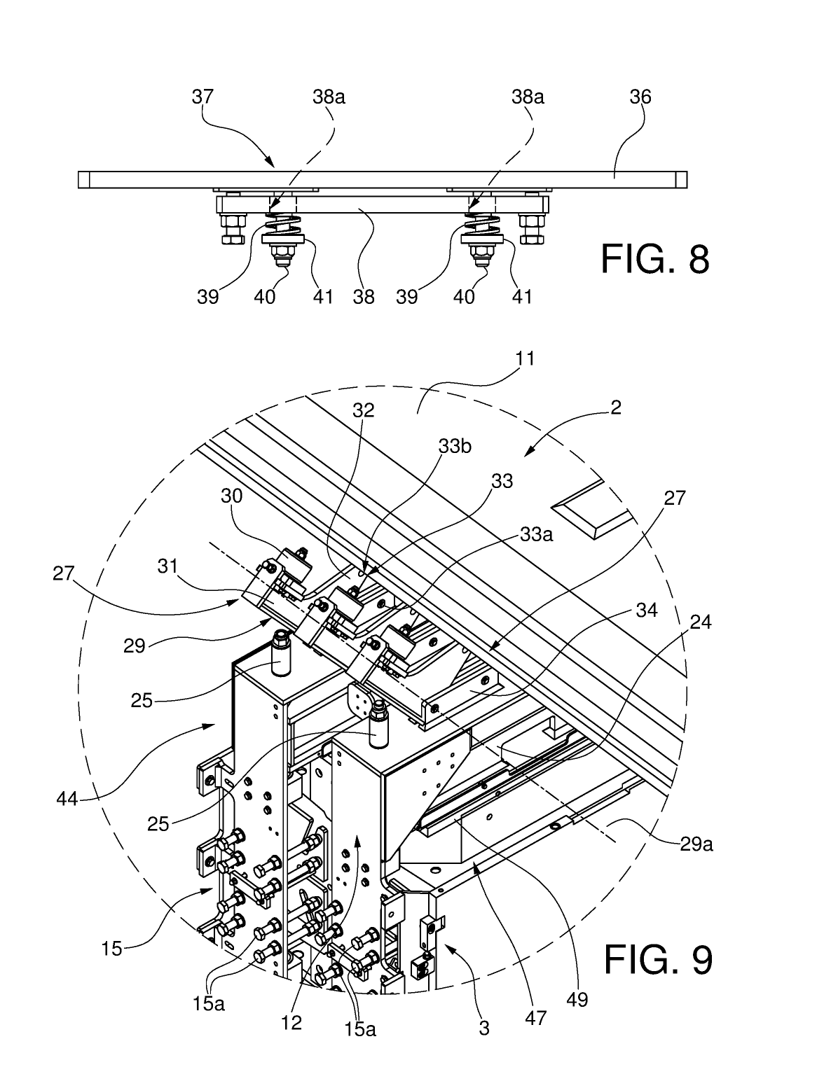

More particularly, such elastic connecting means 37—see FIG. 8—comprise at least one plate 38 rigidly connected to the frame 35 and parallel to the platform 36; between the platform 36 and the plate 38, elastic members 39 are provided which allow the platform 36 to undergo small oscillations when the pressing member is actuated and the molding unit 1 is brought into the closed configuration.

In the specific embodiment shown in the figures, the elastic connecting means 37 comprise a plurality of through-holes 38a provided in the plate 38 and a corresponding plurality of pins 40 associated with the platform 36 with respective axes orthogonal to the latter.

The aforementioned pins 40 are engaged in these through-holes 38a, and are provided with respective terminal rings 41 for abutment, which are integral with pins 40; said elastic members 39 are interposed between the terminal rings 41 and the plate 38.

More in detail, in an embodiment of the invention, the elastic members 39 consist of helical springs tucked along pins 40 of platform 36.

The elastic coupling means 37 of the type described are only one of the possible alternatives: in other embodiments of the invention other elastic means may be used, still suitable for obtaining the same technical effect.

For example, elastic connecting means 37 may include elastomeric bushings or elastic couplings with other types of spring.

With particular reference to FIGS. 5 and 6, the frame 35 of the second portion 4 is substantially “L” shaped and comprises a first segment 42 and a second segment 43 connected together and forming a certain angle; for example, they can form a right angle between them.

The first segment 42 of the frame 35 is connected, in hanging configuration, to the horizontal structure 11 of the frame 2.

The connection between the frame 35 and the horizontal structure 11 of the frame 2 can be effected by means of at least one first carriage element 27 and a second carriage element 28, in a manner similar to that of the first portion 3 of the molding unit 1.

The platform 36, which in turn bears the second molding component 6, is associated, by means of said elastic connecting means 37, to the second segment 43 of the frame 35.

From what has been described above, it can be seen that, in a specific embodiment of the invention, the molding unit 1 may comprise a first portion 3 and a second portion 4, wherein the respective first and second molding components 5 and 6 are shaped in such a way as to entirely enclose the molding cavity 7.

In a form of embodiment of the invention, the molding unit 1 further comprises a third portion 44, in addition to said first portion 3 and second portion 4.

The third portion 44 defines, along with the first portion 3 and the second portion 4, said molding cavity 7.

A respective third molding component 45 is connected to the third portion 44. From a constructive and structural point of view, the third portion 44 exactly mirrors the first portion 3, possibly excluding the third molding component 45. Or, in some embodiments of the invention, the third molding component 45 may also mirror the first molding component 5; this may be the case, for example, when the sanitary ware 8 to be manufactured has a symmetrical conformation with respect to a particular plan.

However, if the sanitary ware 8 does not have a symmetrical conformation, the third molding component 45 may be geometrically different from the first molding component 5.

The first portion 3 and the third portion 44 are movable along said first direction A in reciprocal approach towards the closed configuration of the molding unit 1 and in reciprocal displacement towards the open configuration of the same unit 1. In this embodiment of the invention, the second portion 4 may be, for example, oriented with the respective platform 36 lying on a parallel or substantially parallel plane, in the first direction A.

In this embodiment, and given the presence of a third portion 44 which may also mirror exactly the first portion 3, the second portion 4 may have a symmetrical or substantially symmetrical configuration with respect to a plane orthogonal to said first direction A.

Therefore, the second portion 4 may comprise two abutment zones 10, possibly mirroring each other with respect to said symmetry plane, and intended to engage respectively in the housings 13 of the first portion 3 and of the third portion 44 of the molding unit 1.

More in detail, the frame 35 and the platform 36 of the second portion 4 are reciprocally connected at the central portion of the platform 36 itself; the two abutment zones 10 are thus provided at two opposite peripheral portions of the platform 36.

In a specific embodiment of the invention, therefore, the molding unit 1 may comprise a first portion 3, a second portion 4, and a third portion 44, respectively having a first molding component 5, a second molding component 6 and a third molding component 45 which, in the closed configuration of the molding unit 1, completely enclose the molding cavity 7.

In an embodiment of the invention, the molding unit 1 comprises a fourth portion 46, in addition to said first portion 3, second portion 4, and third portion 44.

A respective fourth molding component 47 is connected to the fourth portion 46.

The fourth molding component 47 defines, along with the first molding component 5, the second molding component 6, and the third molding component 45, said molding cavity 7.

In the embodiment of the invention illustrated in the figures, the fourth portion 46 is positioned opposite to the second portion 4.

In other embodiments of the invention, however, the fourth portion 46 may have a different positioning and/or a different orientation.

The fourth portion 46 comprises a support member 48; furthermore, the fourth portion 46 comprises a rigid counter-platform 49 connected to said support element 48.

The fourth molding component 47 is secured to said counter-platform 49.

The fourth portion 46 comprises at least one respective coupling zone 50.

The coupling zone 50 is intended to engage in the seat 23 of the first portion 3 or of the third portion 44.

In more detail, said coupling zone 50 comprises a side region of the counter-platform 49, and/or a side of the fourth molding component 47.

In an embodiment of the invention, the support element 48 can be directly attached, in a hanging configuration, to the horizontal structure 11 of frame 2.

In another embodiment of the invention, corresponding to that shown in the attached tables, the support member 48 is associated with the frame 35 of the second portion 4, which in turn is connected in the hanging configuration to the horizontal structure 11 of the frame 2.

In particular, in the embodiment shown in the figures, the support element 48 and the frame 35 are connected to each other so as to realize a single structure in which the platform 36 and the counter-platform 49 can be mutually approached and moved away from each other along a second direction B, in a constructively simple manner (refer to FIG. 5).

In particular, the second direction B may be orthogonal to the first direction A, or a different inclination may be provided between the two directions.

In this specific embodiment, frame 35 of the second portion 4 thus comprises, for this purpose, a fixed part 51 to which the support element 48 is directly connected, and a movable part 52, which includes said first segment 42 and second segment 43: the movable part 52 is translatable, with respect to fixed part 51, along said second direction B.

Between the movable part 52 and the fixed part 51, at least one actuation member 53 is interposed, which realizes the relative translation of the two parts 51 and 52 one relative to the other.

The actuating member 53 can be, for example, linear, pneumatic, or hydraulic, or electric, or any other suitable type for the application.

Similarly to the platform 36 of the second portion 4, the support element 48 is associated with the central portion of the counter-platform 49 via elastic connecting members 54.

In the embodiment shown in the figures, the elastic connecting members 54 of the fourth portion 46 may be entirely identical to the elastic connecting means 37 provided in the second portion 4; reference is therefore made to the description of the elastic connecting means 37 of the second portion 4.

The elastic connecting members 54 may also be of a different type: for example, different elastic connecting member 54 may be used if different behaviours of the two portions 4,46 are intended—for example, different stiffness or suppleness—when the molding unit 1 is in closed configuration, and therefore when the clamping means 9 of the first portion 3 and/or the third portion 4 are active.

In this embodiment of the invention, the hanging connection of the unit comprising the second portion 4 and the third portion 46 to the horizontal structure 11 can be provided with a first carriage element 27 connected to the first segment 42, and a second carriage element 28, having the features described above, connected to the support element 48.

In a specific embodiment of the invention, therefore, the molding unit 1 comprises a first portion 3, a second portion 4, a third portion 44, and a fourth portion 46, opposed two by two, and wherein the respective first molding component 5, second molding component 6, third molding component 45, and fourth molding component 47 completely enclose the molding cavity 7.

In an embodiment of the invention, the molding unit 1 may further comprise a fifth portion 55.

The fifth portion 55 may be, for example, associated with one or more of the other portions 3, 4, 44, 46 of the molding unit.

The fifth portion 55 may optionally be included in the molding unit 1 to obtain particular shape features in the sanitary ware 8, if these features are not readily obtainable using only the four portions 3, 4, 44, 46.

In the embodiment illustrated in the figures, the fifth portion 55 is associated with the frame 35 of the second portion 4 and is used to obtain certain shape features in the back area of the sanitary ware 8.

For example, the fifth portion 55 may be used to obtain an opening, a channel, an undercut, or other similar features.

The shape and dimensions of the fifth portion 55 may be any, without any particular limitations, and also its attachment modes to the other portions 3, 4, 44, 46 may be any.

The molding unit 1 may comprise driving and motion transmission means 56 of one of the portions 3, 4, 44, 46 to the other along the first direction A.

This allows to operate in translation, for example, only one of the portions 3,4,44,46 obtaining the translation of the rest as well, in a very simple and inexpensive way.

Transmission means 56 may be, for example, of the pantograph type, or any other suitable type for the application.

Even the drive means in translation can be of any type suitable for the application. The operation of the molding unit 1 according to the invention is, in the light of the foregoing, completely intuitive.

The following description of the operation relates to a molding unit 1 comprising four portions 3, 4, 44, 46 or five portions 3, 4, 44, 46, 55 such as the one shown in the accompanying figures, but also, as highlighted, to a structurally simpler molding unit 1, also including only two portions 3 and 4, or three portions 3, 4, 44, according to the embodiments illustrated above.

In addition, the description of the operation assumes a configuration of use of the unit 1 as shown in the figures, i.e. with the portions 3, 4, 44, 46, 55 associated with the horizontal structure 11 in the hanging configuration: of course other configurations of use are possible with portions 3, 4, 44, 46, 55 differently oriented. Assuming starting from the open configuration of the molding unit 1 shown in FIG. 2, the various portions 3, 4, 44, 46, 55 reciprocally approach so as to close the molding cavity 7 in which the fluid mixture is cast.

More in detail, the first portion 3 and the third portion 44 are moved in approach to each other along the first direction A; the fixed part 51 and the movable part 52 are at the minimum distance with respect to the second direction B (or are brought to such a minimum distance if they are not initially).

The mutual approach of the first portion 3 and the third portion 44 determines the engagement of the abutment zones 10 of the second portion 4 in the housings 13 of the first portion 3 and of the third portion 44 themselves; furthermore, the engagement of the coupling zones 50 of the fourth portion 46 is obtained in the seats 23 of said first portion 3 and third portion 44.

Once this configuration is obtained—as shown in FIG. 1—molds 5, 6, 45, 47 enclose the molding cavity 7, as they are in mutual contact along the respective junction surfaces.

At this point, according to the present invention, prior to casting the fluid mixture, the clamping means 9 of the first portion 3 or the third portion 44 or of both portions 3, 44 are actuated.

In this way, a mutual approach motion towards the second cross member 24 is applied to the first cross member 19, which in the illustrated embodiment is a vertical or substantially vertical motion; the pressure surface 20 of each first cross member 19 then presses against the respective abutment zone 10 provided in the rigid platform 36 so that deformations due to the pressure of the fluid mixture are provided at the junction surfaces between the molds 5, 6, 45, 47 and thus an optimal seal is guaranteed, therefore avoiding any possible drawbacks that may arise.

The reciprocal pressure action of each first cross member 19 and of each second cross member 24 is transmitted through the first molding component 5 and the third molding component 45 to the fourth molding component 47 of the fourth portion 46 whose counter-platform 49 abuts on the second cross members 24 of the first portion 3 and the third portion 44.

In other words, the action of the clamping means 9—that is, the pressing member 14—is transmitted to all the junction surfaces between the molds 5, 6, 45, 47 so that in all the zones of the molding chamber 7 the pressure of the fluid mixture is effectively counteracted.

When the casting and the subsequent solidification phase of the sanitary ware 8 are finished, the molding unit 1 is brought to the open configuration of FIG. 2; also the second portion 4 and the third portion 44 are moved away from each other, so that the sanitary ware 8 can be completely removed from the molding cavity.

It is to be understood that the object of the present invention is also a molding line comprising at least one molding unit 1 as described above.

In more detail, said molding line comprises a plurality of molding units 1 of the type described above, all connected in a hanging configuration and side by side along the horizontal structure 11 of the frame 2.

The molding line comprises pressure means provided at the ends of the horizontal structure 11 and acting on the flat elements 18 of the first, third portions 3, 44 of the molding units 1 placed at the ends of said plurality.

As previously explained, the action of these pressure means allows to compact the molding units 1 side by side to compensate for the pressure of the fluid mixture cast into the molding cavities 7 at least along the first direction A; this action, combined with that of the clamping devices 9 described above, provided in the first portion 3 and the third portion 44, limits the possible deformations of the molds 5, 6, 45, 47 of the molding units at the respective junction zones, and therefore also the possible consequences that may arise therefrom, such as fluid leaks, residual stresses, and so on.

It has thus been seen how the invention achieves the intended purposes. The deformations of the molds at the junction areas, and therefore the possible problems related to fluid leaks or defects in sanitary wares 8, are limited or are entirely eliminated with a more effective technical solution than those currently present on the market.

In fact, all the disadvantages due, for example, to the use of inflatable items to obtain the same effects are eliminated.

The adopted technical solution is constructively simpler and cheaper than those of the known type.

Even in the case of maintenance interventions, the molding unit is easy to disassemble, since it is made up of a limited number of components.

Moreover, the technical solution according to the present invention is characterized by a greater durability over the known types of solutions, as the wear problems of the elastomeric parts composing said inflatable elements are completely eliminated.

It should further be added that the technical solution object of the present invention provides a more precise control of the action of counteracting the fluid pressure, as it includes rigid movable mechanical parts, unlike the currently available solutions that include deformable parts: the linear actuators 21 may be associated with respective adjustment means to achieve the desired force values, possibly even differentiated between the two actuators 21 provided in the first portion 3 and the third portion 44.

The molding unit for sanitary wares according to the present invention can also easily find use in pre-existing production plants for the integration or replacement of pre-existing production units or lines.

The invention thus conceived is susceptible to numerous modifications and variations, all falling within the inventive concept.

Further, all the details can be replaced by other technically equivalent elements. In practice, the materials employed, as well as the shapes and the dimensions, may be any according to requirements without thereby abandoning the scope of protection of the following claims.

1. A molding unit (1) for the production of sanitary wares, comprising at least one support frame (2), at least one first portion (3) and one second portion (4), associated with said frame (2), bearing respectively at least one first molding component (5) and one second molding component (6) selectively connectable to each other, so as to define at least one molding cavity (7) adapted to receive the casting of at least one pressurized fluid mixture which, once solidified, forms at least one sanitary ware (8), said first portion (3) and second portion (4) being connected to said frame (2) according to a hanging configuration and being able to be selectively and mutually approached in a closed configuration, so as to bring into mutual contact said molds (5,6) to define said at least one molding cavity (7), and mutually movable away from each other in an open configuration to allow the removal of the sanitary ware (8) once formed within said cavity (7), wherein at least said first portion (3) comprises clamping means (9) selectively movable from an inactive position, corresponding to said open configuration, to an operating position, corresponding to said closed configuration, in which they act on at least one abutment zone (10) of said second portion (4) and corresponding to at least one junction surface between said first molding component (5) and said second molding component (6) in said closed configuration.

2. The molding unit according to claim 1, in which said clamping means (9) comprise elastic means (25) to connect in a floating manner said clamping means (9) to said first portion (3) and/or said second portion (4).

3. The molding Unit unit according to laim 2, in which said elastic means (25) comprise elastomeric bushings or other types of elastic coupling.

4. The molding unit according to claim 1, in which said clamping means (9) comprise at least one housing (13) provided in said first portion (3) and at least one pressing member (14) which defines at least one of the inner surfaces of said housing (13), said abutment zone (10) of said second portion (4), in said closed configuration of said molding unit (1), being at least partially engaged in said housing (13).

5. The molding unit according to claim 4, in which said housing (13) is defined by said pressing member (14) and by a portion of the perimeter surface (5b) of said first molding component (5) coupled with said first portion (3).

6. The molding unit according to claim 5, in which said abutment zone (10) comprises one peripheral portion of said second molding component (6) coupled with said second portion (4).

7. The molding unit according to claim 5, in which said first portion (3) comprises at least one support reinforcement (12), said pressing member (14) comprising at least one cross member (19), which can be moved from said inactive position to said operating position, having at least one pressure surface (20) adapted to act on said abutment zone (10), and which defines at least one of the inner surfaces of said housing (13), and at least one linear actuator (21) to operate in translation said at least one first cross member (19), said linear actuator (21) comprising at least one part rigidly connected to said supporting reinforcement (12).

8. The molding unit according to claim 7, in which said linear actuator (21) comprises one cylinder (21a) and one stem (21b) which selectively comes out of said cylinder (21a), said first cross member (19) being rigidly connected to said cylinder (21a), being provided with at least one rod (22) which connects, in a coaxial manner, said stem (21a) to said supporting reinforcement (12) so that, during the translation from said inactive position to said operating position of said first cross member (19), the operation of said linear actuator (21) determines the translation of said first cross member (19) towards said supporting reinforcement (12), and thereby towards said first molding component (5).

9. The molding unit according to claim 8, in which said pressing member (14) comprises at least two linear actuators (21) having corresponding drive axes (21c) parallel to each other, said first cross member (19) being rigidly connected, at opposite ends, to said cylinders (21a), at least two rods (22) being provided connecting, respectively, in a coaxial manner, said stems (21b) to said supporting reinforcement (12).

10. The molding unit according to claim 9, in which said first cross member (19) has a substantially elongated conformation and comprises at the opposite ends thereof, at least two through-holes (19b) within which said stems (21b) of said linear actuators (21) and said rods (22) are slidably engaged.

11. The molding unit according to claim 1, in which said second portion (4) comprises at least one rigid platform (36) having one first face (36a) to which said second molding component (6) is connected, and a second face (36b), opposite to said first face (36a), comprising said abutment zone (10).

12. The molding unit according to claim 11, in which said second portion (4) comprises a frame (35) with which said platform (36) is associated through elastic connecting means (37).

13. The molding unit according to claim 12, in which said elastic connecting means (37) comprise at least one plate (38) having a plurality of through-holes (38a), and a corresponding plurality of pins (40) associated with said platform (36) with the respective axes orthogonal to the latter, said pins (40) being engaged in said through-holes (38a) and being provided with respective terminal rings (41) for abutment, with respective elastic members (39) being interposed between said terminal rings (41) and said plate (38).

14. The molding unit according to claim 11, further comprising a third portion (44) to which a respective third molding component (45) is fixed, said third portion (44) being a mirror image of said first portion (3) except for the features of said third molding component (45), said first portion (3) and said third portion (44) being movable, along one same first direction (A), mutually approaching towards said closed configuration and mutually moving away towards said open configuration, said second portion (4) being oriented with said platform (36) lying on a parallel plane, or substantially parallel, to said first direction (A).

15. The molding unit according to claim 14, in which said second portion (4) comprises a frame (35) with which said platform (36) is associated through elastic connecting means (37), in which said second portion (4) is symmetrical with respect to the plane orthogonal to said first direction (A) and comprises two of said abutment zones (10) specular to each other with respect to said plane, said two abutment zones (10) being intended to engage respectively said housings (13) of said first portion (3) and said third portion (44), said frame (35) and said platform (36) being mutually connected at the central portion of said platform (36), said abutment zones (10) being provided at two opposite peripheral portions of said platform (36).

16. The molding unit according to claim 14, comprising at least one fourth portion (46) to which a respective fourth molding component (47) is fixed, said fourth portion (46) being provided with at least one respective coupling zone (50) intended to engage in a respective seat (23) of said first portion (3) or of said third portion (44).

17. The molding unit according to claim 16, in which said seat (23) is placed opposite to said housing (13) with respect to said first molding component (5) of said first portion (3) or with respect to said third molding component (45) of said third portion (44), said seat (23) being delimited between one section (12b) of said reinforcement (12) and one perimeter surface portion (5b, 45b) of said first molding component (5) or of said third molding component (45).

18. The molding unit according to claim 16, in which said fourth portion (46) is placed opposite to said second portion (4) and comprises one support element (48) and one counter-platform (49) coupled with said support element (48), a respective fourth molding component (47) being fixed to said counter-platform (49).

19. The molding unit according to claim 18, in which said coupling zone (50) of said fourth portion (46) comprises one lateral region of said counter-platform (49) and one side of said fourth molding component (47).

20. The molding unit according to claim 18, in which said support element (48) is associated with the central portion of said counter-platform (49) through elastic connecting members (54), similar in type to said elastic connecting means (37) or different in type.

21. The molding unit according to claim 1, in which said frame (2) comprises at least one horizontal, or substantially horizontal, structure (11) to which at least one of said portions (3, 4, 44) is connected in a hanging configuration singularly or in groups through a first carriage element (27) and a second carriage element (28) movable along respective tracks of said horizontal structure (11), at least said second carriage element (28) being movable from an operating position of coupling to said horizontal structure (11) to an inactive position of free uncoupling of said portion (3, 4) from said horizontal structure (11).

22. The molding unit according to claim 21, in which said second carriage element (28) comprises at least one bracket (29), articulated to fixed parts of said portions (3, 4), and having at least one wheel (3) intended to rotate along one respective track of said horizontal structure (11), said bracket (29) being rotatable between said operating position of coupling and said inactive position of free uncoupling.

23. The molding unit according to claim 22, in which said bracket (29) is substantially formed as a bracket articulated to fixed parts of said portion (3, 4) at the vertex thereof, said wheel (30) being supported rotatable at the terminal portion of one first arm (31) of said bracket (29), the second arm (32) of said bracket (2) comprising means of constraint (33) to fixed parts of said portion (3, 4, 44).

24. A line for the molding of sanitary wares (8), comprising a support frame (2) provided with at least one horizontal structure (11), a plurality of molding units (1) according to any one of the preceding claims, connected to said horizontal structure (11) according to a hanging configuration and side by side each other, and pressure means provided at the ends of said horizontal structure (11), which act on flat elements (18) of the molding units (1) which are found at the ends of said plurality, so as to retain said molding units (1) in the respective closed configurations in which they delimit the respective molding cavities (7).
